(19) United States
(12) Patent Application Publication
(10) Pub. No.: US 2014/0052286 A1
(43) Pub. Date: Feb. 20, 2014

(54) OBJECT TRANSFER METHOD AND OBJECT PROCESSING APPARATUS

(71) Applicant: Hiromitsu Sakaue, Yamanashi (JP)

(72) Inventor: Hiromitsu Sakaue, Yamanashi (JP)

(73) Assignee: TOKYO ELECTRON LIMITED, Tokyo (JP)

(21) Appl. No.: 14/000,286

(22) PCT Filed: Feb. 14, 2012
(86) PCT No.: PCT/JP2012/053405

§ 371 Date: Oct. 28, 2013

(30) Foreign Application Priority Data
Feb. 17, 2011 (JP) 2011-032081

(51) Int. Cl. G05B 19/418

(52) U.S. Cl. CPC G05B 19/4189
USPC 700/112

(57) ABSTRACT

Disclosed are an object transfer method and an object processing apparatus. The object transfer method includes: extending a first transfer arm into a processing chamber, and retracting the same after a first pick picking up an processed object accommodated in the processing chamber; rotating the first and second transfer arms to move a second pick holding an unprocessed object to a transfer position in front of the processing chamber and to move the first pick holding the processed object to a position adjacent to a transfer position in front of a load-lock chamber; extending the second transfer arm into the processing chamber, and retracting the same after accommodating the unprocessed object held by the second pick in the processing chamber; and rotating the second transfer arm to move the second pick holding no object to the transfer position in front of the load-lock chamber.

### FIELD OF THE INVENTION

The present invention relates to a method for transferring an object to be processed and an apparatus for processing an object.

### BACKGROUND OF THE INVENTION

In manufacturing an electronic device, an object to be processed is used, and various processes such as film formation, etching, and the like are performed on the object. For example, in manufacturing a semiconductor integrated circuit device, a semiconductor wafer is used as an object to be processed, and various processes such as film formation, etching, and the like are performed on the semiconductor wafer. In general, such processes are carried out in separate processing apparatuses. For example, a film forming process is performed in a film forming apparatus having a film forming chamber, and an etching process is performed in an etching apparatus having an etching chamber.

Recently, in order to obtain a processing consistency and suppress an increase in a footprint accompanied by an increase in the number of the processing apparatuses, there has been widely used a multi-chamber (cluster tool) type processing apparatus in which a plurality of processing chambers is arranged around a transfer chamber. A typical example of the multi chamber-type processing apparatus is disclosed in, e.g., Patent Document 1.

Further, as disclosed in Patent Documents 1 and 2, a transfer unit employing an articulated robot is used to transfer the object between the transfer chamber and the processing chambers.
Patent Document 1: Japanese Patent Application Publication No. 2005-64509
Patent Document 2: Japanese Patent Application Publication No. 2004-282002

In various processes such as film formation, etching, and the like, a reduced processing time is required in order to improve the productivity.

However, once the reduction in the processing time of the respective processes is achieved, a rate limiting factor for the time required for the processing of the multi-chamber type processing apparatus is changed from a process rate limiting to a transfer rate limiting. For this reason, even if the processing time is substantially reduced, the improvement in the productivity is limited.

### SUMMARY OF THE INVENTION

In view of the above, the present invention provides an object transfer method and an object processing apparatus, which can solve the problem of limited the productivity even if the processing time is shortened.

In accordance with a first aspect of the present invention, there is provided an object transfer method performed by an object processing apparatus which includes: a transfer chamber in which a transfer mechanism for transferring an object is disposed; a plurality of processing chambers, disposed around the transfer chamber, for processing the object; and a plurality of load-lock chambers, disposed around the transfer chamber, for switching an environment around the object to an environment inside the transfer chamber, wherein the transfer mechanism has at least two transfer arms including a first and a second transfer arm that are capable of extending, retracting, and rotating individually, and at least two picks including a first and a second pick attached to the first and the second transfer arm, respectively, for holding the object, the object transfer method includes: (0) rotating the first and the second transfer arm to move the first pick holding no object to a first transfer position in front of a first processing chamber of the processing chambers and to move the second pick holding an unprocessed first object to a position adjacent to the first transfer position; (1) extending the first transfer arm into the first processing chamber, transferring a processed second object accommodated in the first processing chamber to the first pick, and retracting the first transfer arm; (2) rotating the first and the second transfer arm to move the second pick holding the unprocessed first object to the first transfer position and to move the first pick holding the processed second object to a position adjacent to a second transfer position in front of a first load-lock chamber among the load-lock chambers; (3) extending the second transfer arm into the first processing chamber, accommodating the unprocessed first object held by the second pick in the first processing chamber, and retracting the second transfer arm; (4) rotating the second transfer arm to move the second pick holding no object to the second transfer position; (5) extending the second transfer arm into the first load-lock chamber, transferring an unprocessed third object accommodated in the first load-lock chamber to the second pick, and retracting the second transfer arm; (6) rotating the first and the second transfer arm to move the first pick holding the processed second object to the second transfer position and to move the second pick holding the unprocessed third object to a position adjacent to the second transfer position; and (7) extending the first transfer arm into the first load-lock chamber, accommodating the processed second object held by the first pick in the first load-lock chamber, and retracting the first transfer arm.

In accordance with a second aspect of the present invention, there is provided an object transfer method, wherein an object transfer method of simultaneously exchanging an unprocessed object and a processed object and the object transfer method described in claim 1 or 2 are switched depending on a length of a process recipe time.

In accordance with a third aspect of the present invention, there is provided an object processing apparatus, including: a transfer chamber in which a transfer mechanism for transferring an object is disposed; a plurality of processing chambers, disposed around the transfer chamber, for processing the object; a plurality of load-lock chambers, disposed around the transfer chamber, for switching an environment around the object to an environment inside the transfer chamber; and a process controller configured to control at least the transfer mechanism, wherein the transfer mechanism has at least two transfer arms including a first and a second transfer arm that are capable of extending, retracting, and rotating individually and at least two picks including a first and a second pick attached to the first and the second transfer arm, respectively, for holding the object, wherein the process controller controls the transfer mechanism to perform the object transfer method in accordance with the second aspect of the present invention.

### BRIEF DESCRIPTION OF THE DRAWINGS

FIG. 1 is a top view schematically showing an example of an object processing apparatus capable of performing an object transfer method in accordance with a first embodiment of the present invention.

FIGS. 2A to 2D are enlarged views of a transfer mechanism.

FIGS. 3A to 3L are top views showing transfer sequences of an example of the object transfer method in accordance with the first embodiment of the present invention.

FIG. 4A is a timing diagram of an example of the object transfer method in accordance with the first embodiment of the present invention.

FIG. 4B is a timing diagram of an example of an object transfer method in accordance with a reference example.

FIG. 4C is a timing diagram of an example of an object transfer method in accordance with a second embodiment of the present invention.

FIGS. 5A to 5L are top views showing transfer sequences of an example of the object transfer method in accordance with the reference example of the present invention.

FIG. 6 shows the relationship between a process recipe time and a throughput.

FIGS. 7A to 7F are top views showing transfer sequences of an example of the object transfer method in accordance with the second embodiment of the present invention.

FIG. 8A is a timing diagram showing a period of time available for opening and closing gate valves in a simultaneous exchange operation.

FIG. 8B is a timing diagram when a system rate limiting occurs.

FIG. 8C is a timing diagram showing a period of time available for opening and closing gate valves in the object transfer method in accordance with the second embodiment of the present invention.

FIG. 9A shows the relationship between a throughput and a process recipe time of the first embodiment and the transfer method for performing the simultaneous exchange operation.

FIG. 9B is an enlarged view of a frame 9B shown in FIG. 9A.

### DETAILED DESCRIPTION OF THE EMBODIMENTS

Hereinafter, embodiments of the present invention will be described with reference to the accompanying drawings. In this description, like reference numerals will be given to like parts throughout the accompanying drawings.

### First Embodiment

(Apparatus for Processing an Object)

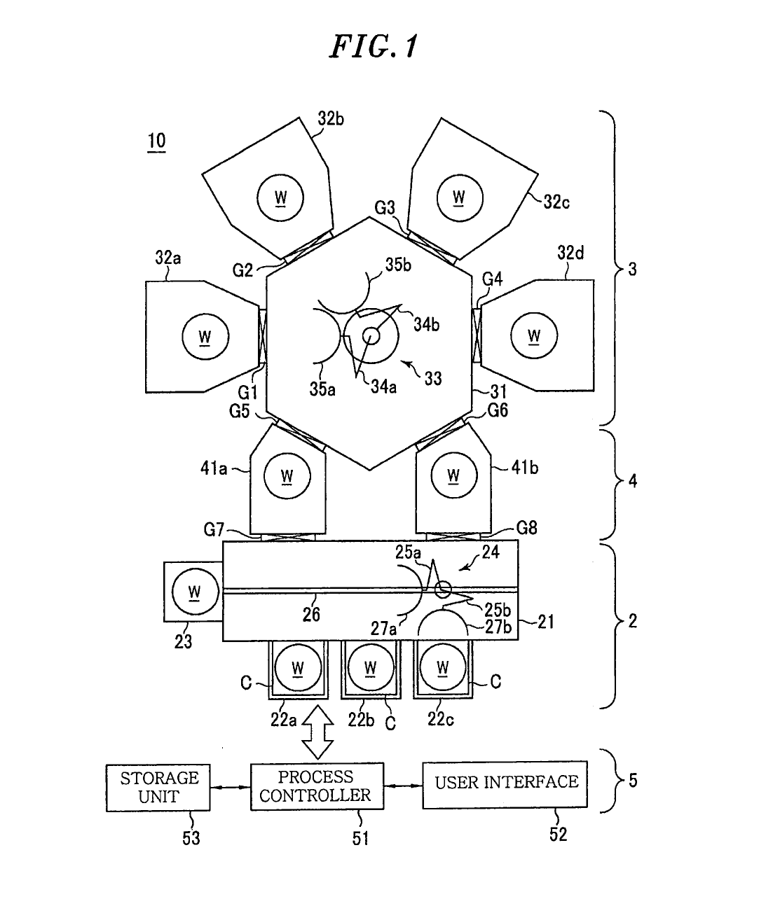

FIG. 1 is a top view schematically showing an example of an object processing apparatus capable of performing an object transfer method in accordance with a first embodiment of the present invention. In this example, a multi-chamber (cluster tool) type semiconductor manufacturing apparatus using a semiconductor wafer as an object to be processed is described as an example of the object processing apparatus.

As shown in FIG. 1, a semiconductor manufacturing apparatus 1 includes: a loading/unloading unit 2 for loading and unloading a semiconductor wafer (hereinafter, referred to as “wafer”) W as an object to be processed between the semiconductor manufacturing apparatus 1 and the outside; a processing unit 3 for processing the wafer W; a load-lock unit 4 for loading and unloading the wafer W between the loading/unloading unit 2 and the processing unit 3; and a control unit 5 for controlling the semiconductor manufacturing apparatus 1.

The loading/unloading unit 2 has a loading/unloading chamber 21. The pressure inside the loading/unloading chamber 21 can be controlled to the atmospheric pressure or an approximate atmospheric pressure, e.g., a slight positive pressure with respect to the outside atmospheric pressure. In this example, the loading/unloading chamber 21 has a rectangular shape having longer sides and shorter sides perpendicular to the longer sides, when seen from the top. One of the longer sides of the loading/unloading chamber 21 is opposite to the processing unit 3 through the load-lock unit 4. One or more loading ports 22 for mounting a carrier C that is either empty or accommodating therein wafers W are provided at the other of the longer sides of the loading/unloading chamber 21. In this example, three loading ports 22a to 22c are provided. The number of the loading ports 22 is not limited to three and may be varied. Each of the loading ports 22a to 22c is provided with a shutter (not shown). When the carrier C is mounted on any one of the loading ports 22a to 22c, the shutter is opened. Accordingly, the inner space of the carrier C communicates with that of the loading/unloading chamber 21 while preventing the intrusion of the outside air. Provided at a shorter side of the loading/unloading chamber 21 is an orienter 23 for aligning the orientation of the wafer W unloaded from the carrier C.

The processing unit 3 includes a transfer chamber 31 and a plurality of processing chambers 32 for processing the wafers W. In this example, one transfer chamber 31 and four processing chambers 32a to 32d disposed around the transfer chamber 31 are provided. Each of the processing chambers 32a to 32d is configured as a vacuum chamber having an inner space that can be evacuated to a predetermined vacuum level. The processing such as film formation, etching, or the like is performed in each of the processing chambers 32a to 32d. The processing chambers 32a to 32d are connected to the transfer chamber 31 through gate valves G1 to G4, respectively.

The load-lock unit 4 includes a plurality of load-lock chambers 41. In this example, two load-lock chambers 41a and 41b are disposed around the transfer chamber 31. Each of the load-lock chambers 41a and 41b is configured as a vacuum chamber having an inner space that can be evacuated to a predetermined vacuum level, and the pressure therein can be changed between the predetermined vacuum level and the atmospheric pressure or the approximate atmospheric pressure. Accordingly, the environment around the wafer W is converted to the environment inside the transfer chamber 31. The load-lock chambers 41a and 41b are connected to the transfer chamber 31 through gate valves G5 and G6 and also connected to the loading/unloading chamber 21 through gate valves G7 and G8, respectively.

The loading/unloading mechanism 24 is provided inside the loading/unloading chamber 21. The loading/unloading mechanism 24 performs loading and unloading of the wafers W between the carrier C and the loading/unloading chamber 21, between the loading/unloading chamber 21 and the orienter 23, and between the loading/unloading chamber 21 and the load-lock chambers 41a and 41b. The loading/unloading mechanism 24 has a plurality of multi-joint arms 25, and can travel on a rail 26 extending along the longer side direction of the loading/unloading chamber 21. In this example, two multi-joint arms 25a and 25b are provided. The multi-joint arms 25a and 25b have hands 27a and 27b at leading ends thereof, respectively. In case that the wafer W is loaded into the processing unit 3, the wafer W is unloaded from the carrier C by the hand 27a or 27b and then loaded into the orienter 23. Next, the orientation of the wafer W is adjusted by the orienter 23. Thereafter, the wafer W is unloaded from the orienter 23 by the hand 27a or 27b and then loaded into the load-lock chamber 41a or 41b. On the contrary, in case that the wafer W is unloaded from the processing unit 3, the wafer W is unloaded from the load-lock chamber 41a or 41b by the hand 27a or 27b and then loaded into the carrier C.

The control unit 5 includes a process controller 51, a user interface 52, and a storage unit 53. The process controller 51 has a microprocessor (computer). The user interface 52 has a keyboard through which an operator inputs commands to manage the semiconductor manufacturing apparatus 1, a display for visually displaying an operation status of the semiconductor manufacturing apparatus 1, and the like. The storage unit 53 stores therein control programs for implementing various processes performed in the semiconductor manufacturing apparatus 1 under the control of the process controller 51, various data, and recipes for executing processes in the semiconductor manufacturing apparatus 1 according to process conditions. The recipes are stored in a storage medium of the storage unit 53. The storage medium may be a computer readable storage medium, e.g., a hard disk or a portable storage medium such as a CD-ROM, a DVD, a flash memory, or the like. Alternatively, the recipes may be appropriately transmitted from another device via, e.g., a dedicated transmission line. A desired recipe is retrieved from the storage unit 53 by an instruction from the user interface 52 and executed by the process controller 51. Accordingly, the wafer W is processed in the semiconductor manufacturing apparatus 1 under the control of the process controller 51.

A transfer mechanism 33 is provided inside the transfer chamber 31. The transfer mechanism 33 performs loading and unloading of the wafers W between the load-lock chambers 41a and 41b and the transfer chamber 31, and between the transfer chamber 31 and the processing chambers 32a to 32d. In this example, the transfer mechanism 33 is disposed substantially at the center of the transfer chamber 31. The transfer mechanism 33 has a plurality of transfer arms 34 capable of extending, retracting, and rotating. In this example, the transfer mechanism 33 has two transfer arms 34a and 34b. The transfer arms 34a and 34b have picks 35a and 35b at leading ends thereof, respectively. The wafer W held by the pick 35a or 35b is loaded and unloaded between the load-lock chambers 41a and 41b and the transfer chamber 31 and between the transfer chamber 31 and the processing chambers 32a to 32d.

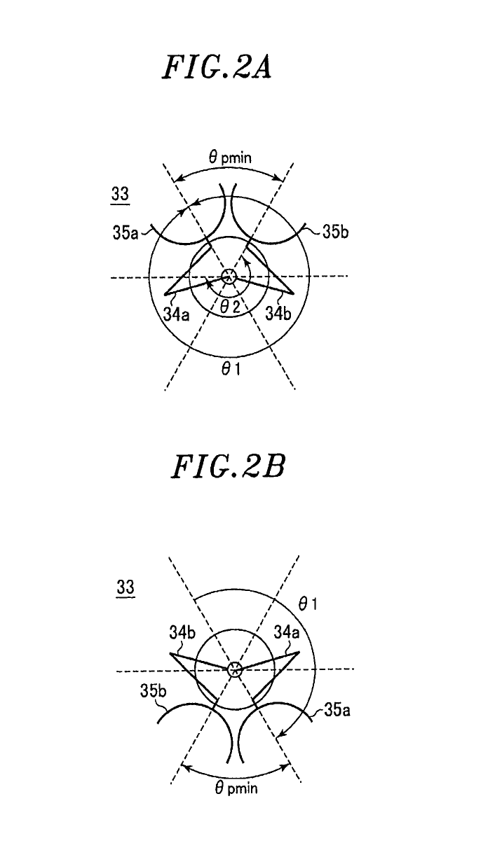

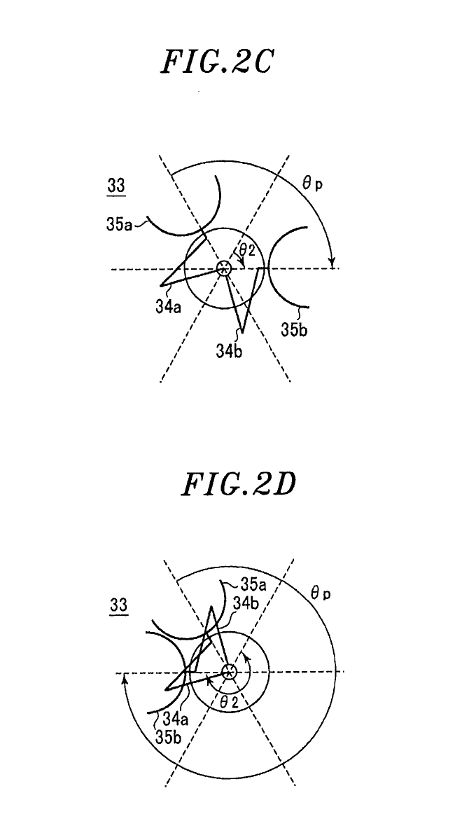

FIGS. 2A to 2D are enlarged views of the transfer mechanism 33 shown in FIG. 1.

As shown in FIG. 2A, the transfer mechanism 33 has a θ1 axis and a θ2 axis as rotation axes.

The θ1 axis is for rotating the transfer arms 34a and 34b together. The θ1 axis can rotate endlessly. For example, the θ1 axis can rotate by about 180° from the state shown in FIG. 2A to the state shown in FIG. 2B in a clockwise direction or a counterclockwise direction and rotate by about 180° from the state shown in FIG. 2B to the state shown in FIG. 2A in a clockwise direction or a counterclockwise direction.

The θ2 axis is for rotating the transfer arm 34b. For example, the θ2 axis can rotate within a maximum rotation angle ranging from 240° to 270°. In this example, the maximum rotation angle is set to 240°. This is because the transfer chamber 31 has a hexagonal shape when viewed from above and a minimum angle θpmin between the picks 35a and 35b is set to 60° (360°−60°−60°=240°). For example, if the transfer chamber 31 has an octagonal shape when viewed from above, the minimum angle θpmin between the picks 35a and 35b is set to 45°. In this case, the maximum rotation angle of the θ2 axis is set to, e.g., 270° (360°−45°−45°=270°). FIG. 2C shows the case in which the transfer arm 34b is rotated by 60° in a clockwise direction by using the θ2 axis and an angle θp between the picks 35a and 35b is increased to 120° in the clockwise direction. FIG. 2D shows the case in which the transfer arm 34b is rotated by 240° in the clockwise direction by using the θ2 axis and the angle θp between the picks 35a and 35b is increased to 300° in the clockwise direction.

The transfer mechanism 33 can rotate the transfer arms 34a and 34b individually by using the θ1 axis and the θ2 axis.

In FIGS. 2A to 2D, the θ2 axis is for rotating the transfer arm 34b; however, the θ2 axis may be for rotating the transfer arm 34a.

(Transfer Method)

Hereinafter, the object transfer method in accordance with the first embodiment of the present invention will be described.

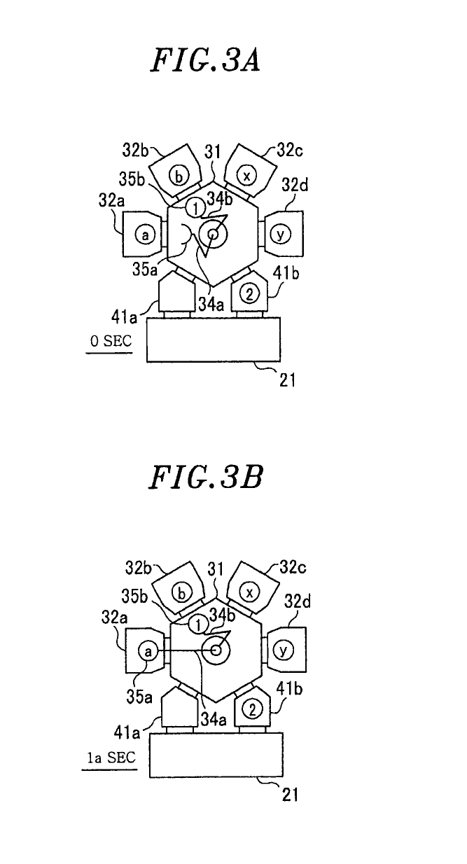

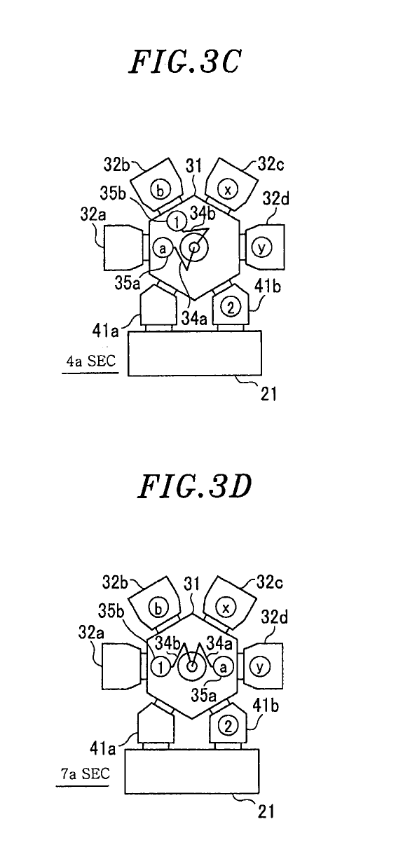

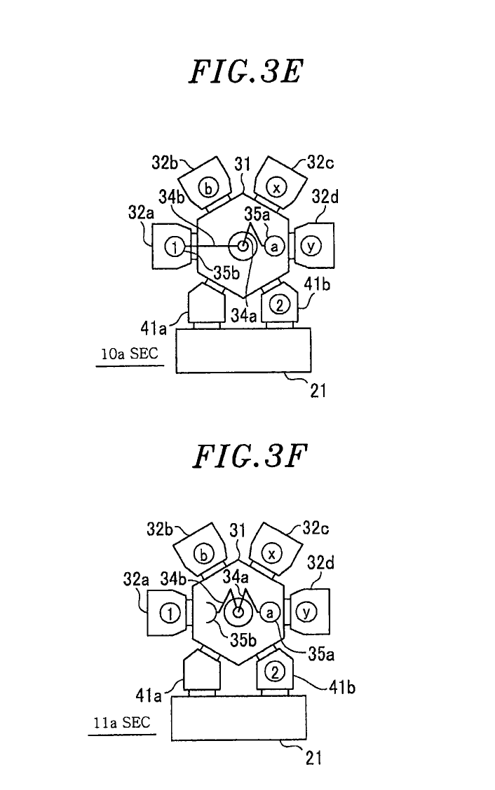

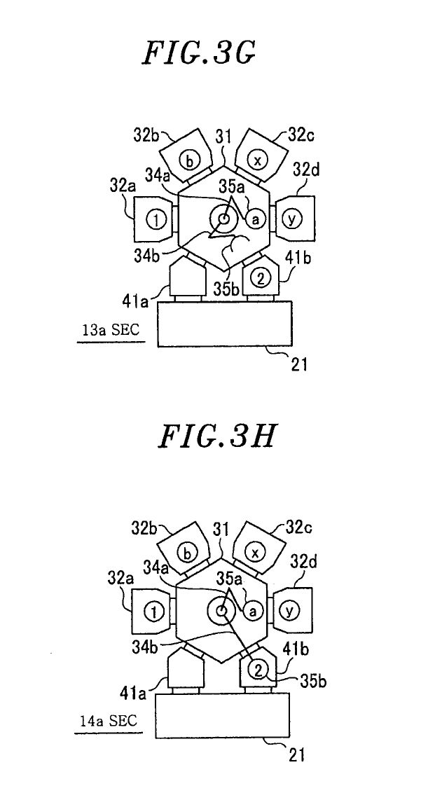

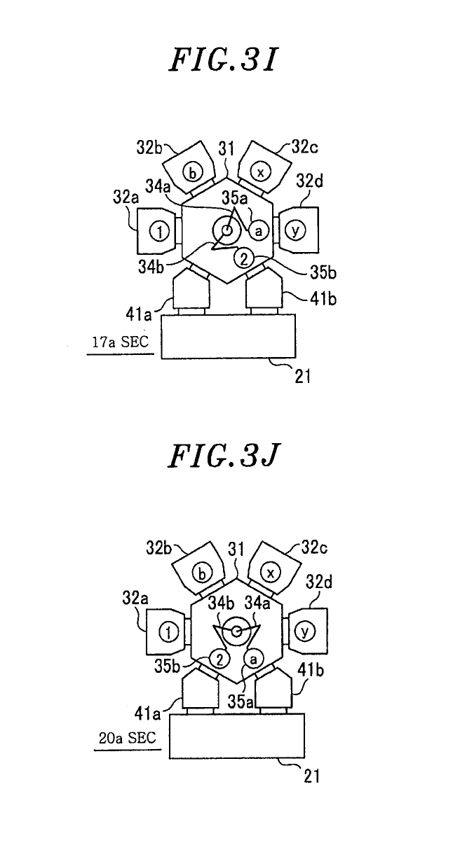

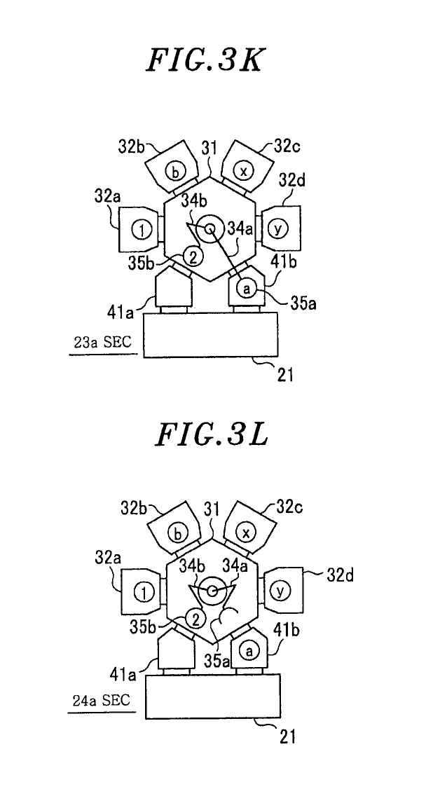

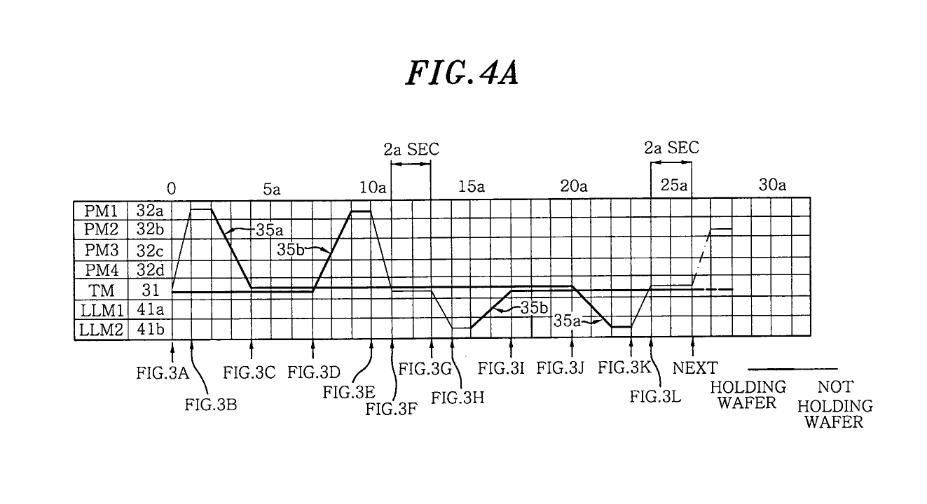

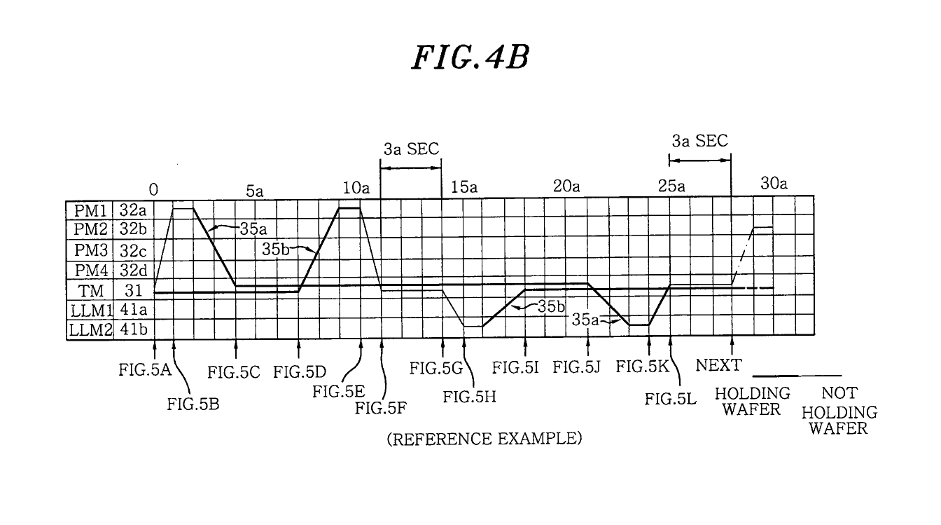

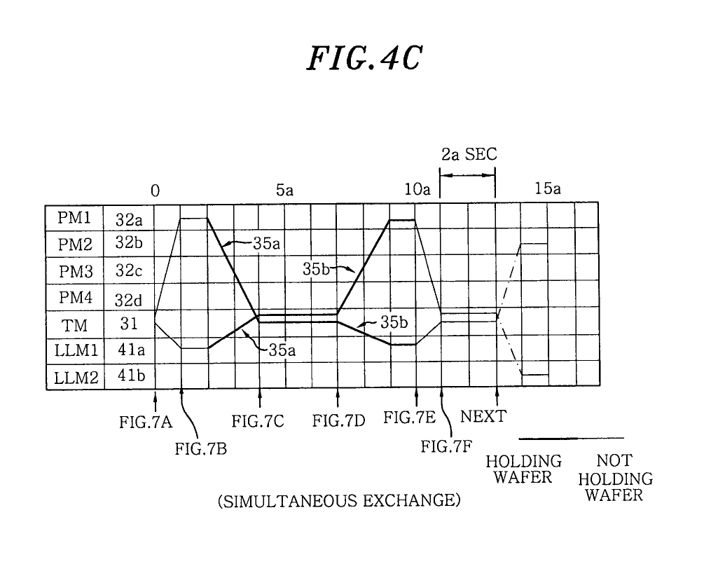

FIGS. 3A to 3L are top views showing an example of transfer sequences of the object transfer method in accordance with the first embodiment of the present invention. FIG. 4A depicts a timing diagram of the example of the transfer method. In FIGS. 3A to 3L, the illustration of the loading ports 22a to 22c and the orienter 23 is omitted.

In this example, the times required to extend, retract, and rotate the transfer arms 34a and 34b are assumed as follows:

“In a state where a wafer is held by the pick 35a or 35b”

Time required to extend the transfer arm 34a or 34b: 2a seconds

Time required to retract the transfer arm 34a or 34b: 2a seconds

Time required to rotate the transfer arm 34a or 34b: 3a seconds “In a state where no wafer is held by the pick 35a or 35b”

Time required to extend the transfer arm 34a or 34b: 1a seconds

Time required to retract the transfer arm 34a or 34b: 1a seconds

Time required to rotate the transfer arm 34a or 34b: 2a seconds

Time required to allow the pick 35a or 35b to pick up the wafer: 1a seconds

Similarly, time required to allow the pick 35a or 35b to transfer the wafer: 1a seconds.

Herein, the suffix notation “a” is a parameter that is a predetermined time that varies depending on the type of the transfer arm.

The sequences of the object transfer method to be described hereinafter are stored in the storage unit 53 together with the process recipe, and the transfer method is performed under the control of the process controller 51. This holds true for a second embodiment to be later described.

First, as shown in FIGS. 3A and 4A, the transfer arms 34a and 34b are rotated, and the pick 35a holding no wafer is moved to a wafer transfer position in front of the processing chamber 32a among the four processing chambers 32a to 32d. Simultaneously, the pick 35b holding an unprocessed wafer “1” is moved to a position adjacent to the wafer transfer position. In this example, the pick 35b is moved to the front of the processing chamber 32b adjacent to the processing chamber 32a.

In this state, the operation of exchanging a processed wafer “a” with an unprocessed wafer “1” is initiated.

At an initial stage of the exchange operation, the transfer arm 34a is extended toward the processing chamber 32a, and the wafer “a” accommodated in the processing chamber 32a is held by the pick 35a.

In this sequence, as shown in FIGS. 3B and 4A, the transfer arm 34a is extended to move the pick 35a from the transfer chamber 31 into the processing chamber 32a. The time required to reach this state is about 1a seconds. Next, as shown in FIGS. 3C and 4A, the wafer “a” accommodated in the processing chamber 32a is held by the pick 35a. Thereafter, the transfer arm 34a is retracted to unload the processed wafer “a” into the transfer chamber 31. The time required to reach this state is about 4a seconds.

Then, there will be carried out a sequence in which the transfer arms 34a and 34b are rotated such that the pick 35b holding the unprocessed wafer “1” is moved to the wafer transfer position in front of the processing chamber 32a and the pick 35a holding the processed wafer “a” is moved to a position adjacent to a wafer transfer position in front of the load-lock chamber 41b. In this example, the pick 35a is moved to the front of the processing chamber 32d adjacent to the load-lock chamber 41b.

In this sequence, as shown in FIGS. 3D and 4A, the transfer arms 34a and 34b are rotated in a counterclockwise direction by using the θ1 axis to move the pick 35b to the wafer transfer position in front of the processing chamber 32a. The transfer arm 34a is rotated in the counterclockwise direction by using the θ1 axis. At this time, it is preferable to keep the transfer arm 34b by using the θ2 axis so that the pick 35b is not moved from the front of the processing chamber 32a. The transfer arm 34a is kept rotating until the pick 35a passes through the front of the load-lock chamber 41b and is positioned in front of the processing chamber 32d adjacent to the load-lock chamber 41b. This is to prevent the pick 35a from disturbing the pick 35b when the pick 35b is moved toward the load-lock chamber 41b. The time required to reach this state is about 7a seconds.

Next, there will be carried out a sequence in which the transfer arm 34b is extended toward the processing chamber 32a, and the unprocessed wafer “1” held by the pick 35b is accommodated in the processing chamber 32a.

In this sequence, as shown in FIGS. 3E and 4A, the transfer arm 34b is extended to move the pick 35b from the transfer chamber 31 into the processing chamber 32a. Thereafter, the unprocessed wafer “1” is transferred from the pick 35b to a mounting table (not shown) in the processing chamber 32a. The time required to reach this state is about 10a seconds. Then, as shown in FIGS. 3F and 4A, the transfer arm 34b is retracted to return the pick 35b from the processing chamber 32a to the transfer chamber 31. The time required to reach this state is about 11a seconds.

Then, there will be carried out a sequence in which the transfer arm 34b is rotated to move the pick 35b holding no wafer to the wafer transfer position in front of the load-lock chamber 41b.

In this sequence, as shown in FIGS. 3G and 4A, the transfer arm 34b is rotated in the counterclockwise direction by using the θ2 axis to move the pick 35b to the wafer transfer position in front of the load-lock chamber 41b. At this time, since the pick 35b holds no wafer, the transfer arm 34b can be rotated more quickly compared to when the pick 35b is holding the wafer. If the pick 35b is holding the wafer, the transfer arm 34b needs to be rotated slowly to prevent the wafer from being misaligned or dropped, and the rotation at this time requires, e.g., about 3a seconds. However, since the pick 35b holds no wafer as in this example, the misalignment or the drop of the wafer may not be considered. Thus, the rotation time may be shortened to, e.g., about 2a seconds. Accordingly, in this example, the time required heretofore to obtain the state shown in FIG. 3G is about 13a seconds.

Next, there will be carried out a sequence in which the transfer arm 34b is extended toward the load-lock chamber 41b, and an unprocessed wafer “2” accommodated in the load-lock chamber 41b is picked up by the pick 35b.

In this sequence, as shown in FIGS. 3H and 4A, the transfer arm 34b is extended to move the pick 35b from the transfer chamber 31 to the load-lock chamber 41b. The time required to reach this state is about 14a seconds. Then, as shown in FIGS. 3I and 4A, the unprocessed wafer “2” in the load-lock chamber 41b is picked up by the pick 35b. Thereafter, the transfer arm 34b is retracted to load the unprocessed wafer “2” into the transfer chamber 31. The time required to reach this state is about 17a seconds.

Then, there will be carried out a sequence in which the transfer arms 34a and 34b are rotated to move the pick 35a holding the processed wafer “a” to the wafer transfer position in front of the load-lock chamber 41b and to move the pick 35b holding the unprocessed wafer “2” to a position adjacent to the wafer transfer position.

In this sequence, as shown in FIGS. 3J and 4A, the transfer arms 34a and 34b are rotated in the clockwise direction by using the θ1 axis to move the pick 35a to the wafer transfer position in front of the load-lock chamber 41b and to move the pick 35b to, e.g., the front of the load-lock chamber 41a. The time required to reach this state is about 20a seconds.

Next, there will be carried out a sequence in which the transfer arm 34a is extended toward the load-lock chamber 41b, and the processed wafer “a” held by the pick 35a is accommodated in the load-lock chamber 41b.

In this sequence, as shown in FIGS. 3K and 4A, the transfer arm 34a is extended to move the pick 35a from the transfer chamber 31 to the load-lock chamber 41b. Thereafter, the processed wafer “a” is transferred from the pick 35a to a mounting table (not shown) in the load-lock chamber 41b. The time required to reach this state is about 23a seconds. Then, as shown in FIGS. 3L and 4A, the transfer arm 34a is retracted to return the pick 35a from the load-lock chamber 41b to the transfer chamber 31. The time required to reach this state is about 24a seconds.

In this manner, the operation of exchanging the processed wafer and the unprocessed wafer “1” is completed.

Next, the next exchange operation for exchanging, e.g., a processed wafer “b” and an unprocessed wafer “2” is carried out. At this time, the pick 35a is moved to a wafer transfer position in front of the processing chamber 32b. The pick 35a holds no wafer and thus can be rotated more quickly by using the θ1 axis compared to the pick 35b holding the unprocessed wafer “2”. The pick 35b may be rotated more slowly by using the θ2 axis compared to the pick 35a. The time needed to move the pick 35a to the front of the processing chamber 32b is about 2a seconds, as shown in FIG. 4A.

Consequently, in the object transfer method of the first embodiment, the time it takes from the beginning of the exchange operation to the next exchange operation is about 26a seconds.

According to the transfer method of the first embodiment, the processed wafer can be exchanged with the unprocessed wafer in about 26a seconds. Therefore, the number of wafers that can be exchanged per one hour is approximately calculated as follows:

3600 seconds÷26a seconds=about 138.5/a wafers.

(Reference Example)

Hereinafter, a reference example will be described to make the advantage of the first embodiment clearer.

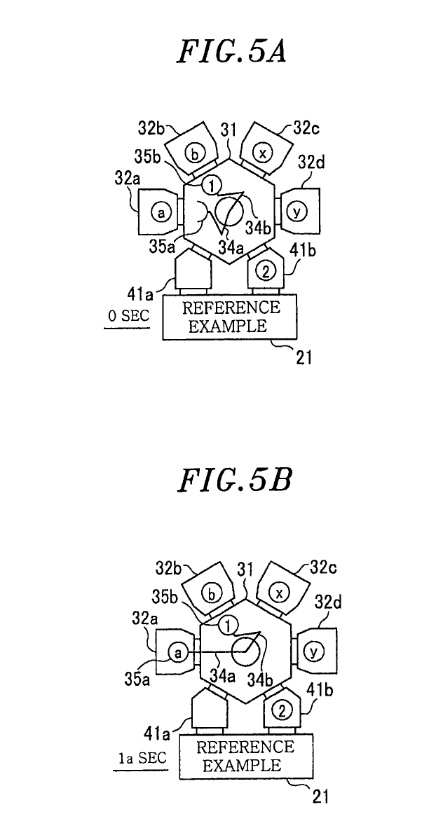

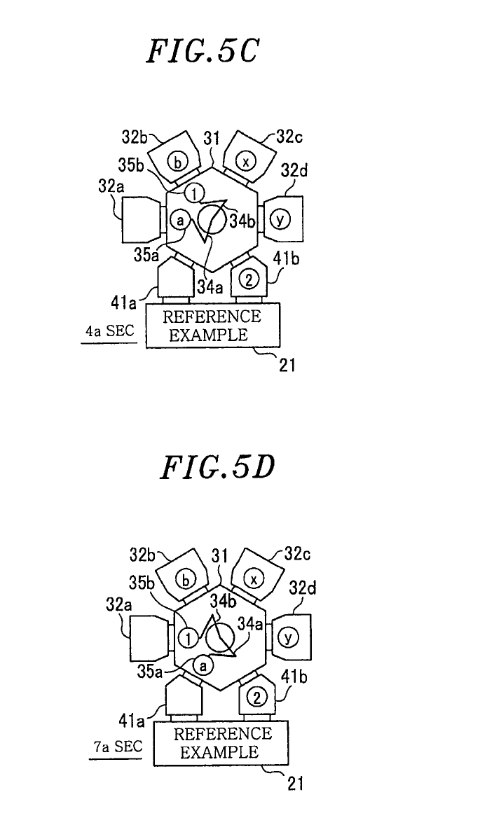

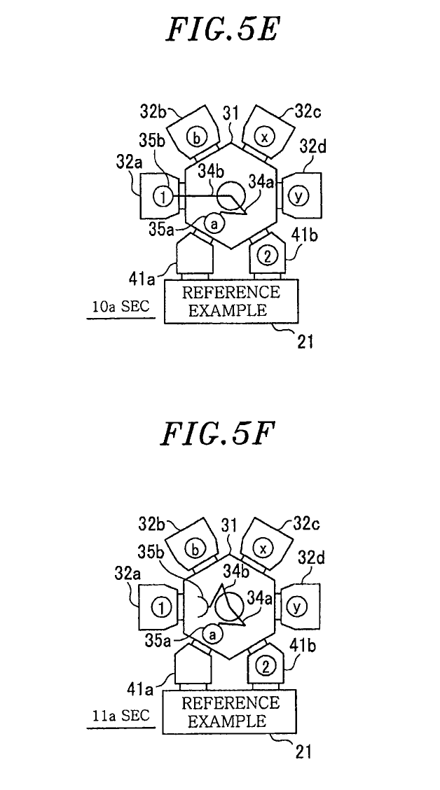

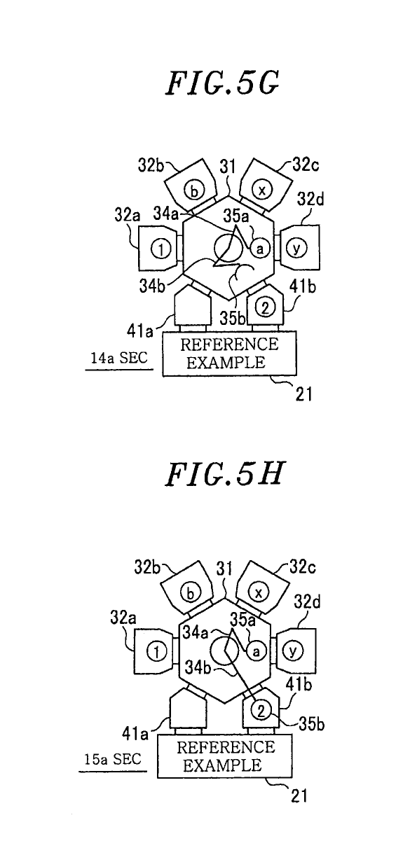

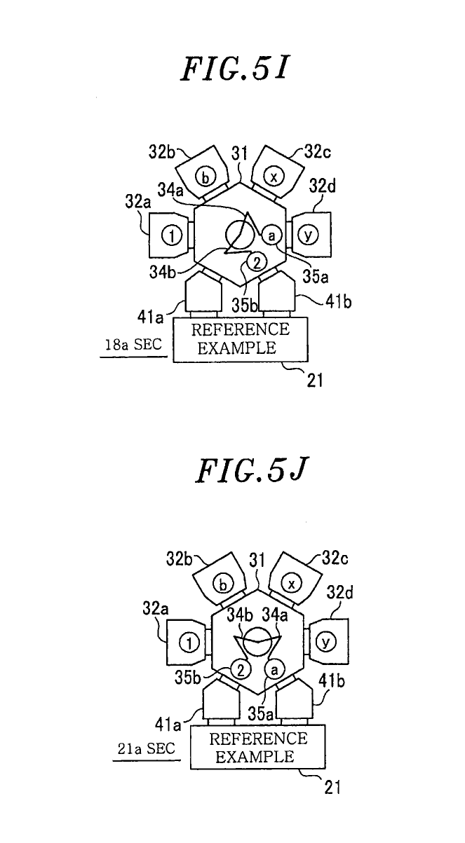

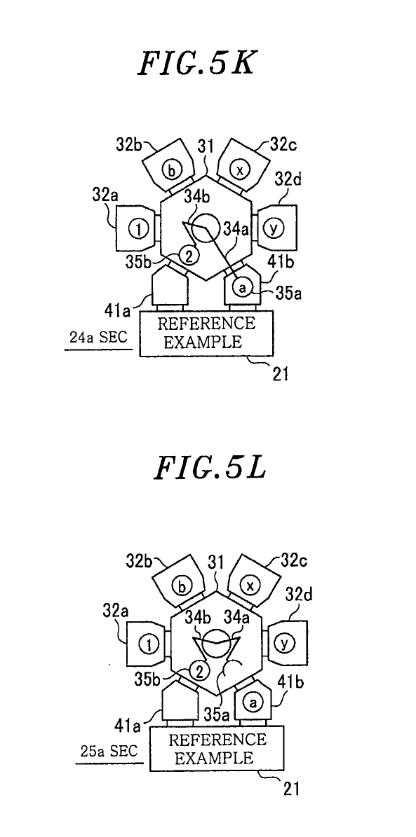

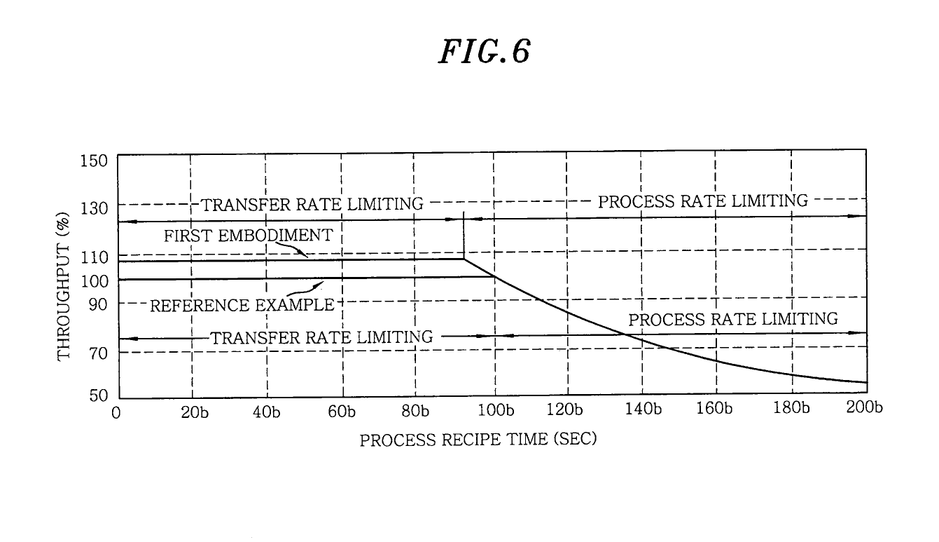

FIGS. 5A to 5L are top views showing transfer sequences of an example of an object transfer method in accordance with a reference example of the present invention. FIG. 4B depicts a timing diagram of the transfer method in accordance with the reference example. Further, in FIGS. 5A to 5L, the illustration of the loading ports 22a to 22c and the orienter 23 is omitted.

In the transfer mechanism used in this reference example, the angle between the transfer arms 34a and 34b is fixed, and the transfer arms 34a and 34b cannot operate individually.

The object transfer method of the reference example is different from the object transfer method of the first embodiment in the steps shown in FIGS. 5D to 5G. The sequences shown in FIGS. 5A to 5C and 5H to 5L are the same as those shown in FIGS. 3A to 3C and 3H to 3L. Therefore, only the different steps will be described.

First, as shown in FIGS. 5D and 4B, the transfer arms 34a and 34b are rotated in the counterclockwise direction to move the pick 35b to the front of the processing chamber 32a. The angle between the transfer arms 34a and 34b is fixed, so that the pick 35a, for example, is positioned in front of the load-lock chamber 41a.

Then, as shown in FIGS. 5E and 4B, the transfer arm 34b is extended to move the pick 35b from the transfer chamber 31 to the processing chamber 32a. Next, the unprocessed wafer “1” is transferred from the pick 35b to the mounting table (not shown) in the processing chamber 32a.

Thereafter, as shown in FIGS. 5F and 4B, the transfer arm 34b is retracted to return the pick 35b from the processing chamber 32a to the transfer chamber 31. The time required to reach this state is about 11a seconds, which is equal to that in the case of the first embodiment.

Thereafter, as shown in FIGS. 5G and 4B, the transfer arms 34a and 34b are rotated in the counterclockwise direction to move the picks 35a and 35b to the front of the processing chamber 32d and the front of the load-lock chamber 41b, respectively. However, the pick 35a is holding the processed wafer “a”, so that the transfer arms 34a and 34b need to be slowly rotated to prevent the processed wafer “a” from being misaligned or dropped. Accordingly, the rotation requires about 3a seconds.

Next, as shown in FIGS. 5H to 5L, similar to the first embodiment, the unprocessed wafer “2” is picked up by the pick 35b, and the processed wafer “a” is transferred to the mounting table (not shown) in the load-lock chamber 41b. The time required to reach this state is about 25a seconds.

Then, the next exchange operation for exchanging, e.g., the processed wafer “b” and the unprocessed wafer “2”, is to be performed. For the next exchange operation, the pick 35a has to be moved to the front of the processing chamber 32b. However, the pick 35b is holding the unprocessed wafer “2” and thus needs to be rotated slowly to prevent the unprocessed wafer “2” from being misaligned or dropped. Accordingly, about 3a seconds is required for such rotation.

Consequently, in the object transfer method of the reference example, the time it takes from the beginning of the exchange operation to the beginning of the next exchange operation is about 28a seconds.

In the transfer method of the reference example, the number of wafers that can be exchanged per one hour is approximately calculated as follows:

3600 seconds÷28a seconds=about 128.6/a wafers.

This indicates that the number of wafers that can be exchanged per one hour in the reference example is reduced by about 10/a compared to that in the first embodiment. In terms of percentage, the throughput in the first embodiment is improved by about 8% compared to that in the reference example.

FIG. 6 shows the relationship between a process recipe time and a throughput. In FIG. 6, the suffix notation “b” is a parameter that is a predetermined time that varies depending on the type of the process.

FIG. 6 compares the throughput of the reference example with that of the first embodiment while setting the process recipe time during which the process rate limiting is changed to the transfer rate limiting to about 100b and the throughput in the transfer rate limiting to about 100%.

As shown in FIG. 6, the first embodiment has a shorter process recipe time during which the process rate limiting is changed to the transfer rate limiting, compared to the reference example. This is because the time from the beginning of the exchange operation to the beginning of the next exchange operation is preferably about 26a seconds and this is shorter than that of the reference example by about 2a seconds. The throughput is improved by about 8% even under the transfer rate limiting, as described above.

When the process recipe time is about 100b or above, the rate limiting factor becomes the process rate limiting both in the first embodiment and the reference example. Therefore, the throughput is not changed both in the first embodiment and the reference example. Consequently, the first embodiment is advantageous for a process having a short process recipe time.

As above, the first embodiment is configured such that the transfer arms 34a and 34b can individually operate. Further, when a pick holding no wafer reaches a wafer transfer position in front of a load-lock chamber, a pick holding a processed wafer is moved to a position that does not disturb the pick holding no wafer. This step prevents the pick holding the processed wafer from rotating when the pick holding no wafer is rotated to the wafer transfer position in front of the load-lock chamber. For this reason, the pick holding no wafer can be more quickly rotated to the front of the load-lock chamber, compared to the case of the pick holding the wafer.

Accordingly, the first embodiment is advantageous in that it provides the object transfer method capable of improving the throughput and solving the problem of limited productivity even if the processing time is shortened in various processes.

### Second Embodiment

In the transfer mechanism 33, the transfer arms 34a and 34b are configured to operate individually. By using this transfer mechanism 33, the transfer method for simultaneously exchanging a processed wafer and an unprocessed wafer can be implemented.

In a second embodiment, the transfer method for simultaneously exchanging a processed wafer and an unprocessed wafer and the transfer method of the first embodiment are switched depending on the process recipe time.

Prior to the description of the second embodiment, an example of the method for simultaneously transferring a processed wafer and an unprocessed wafer which can be used in the second embodiment will be described.

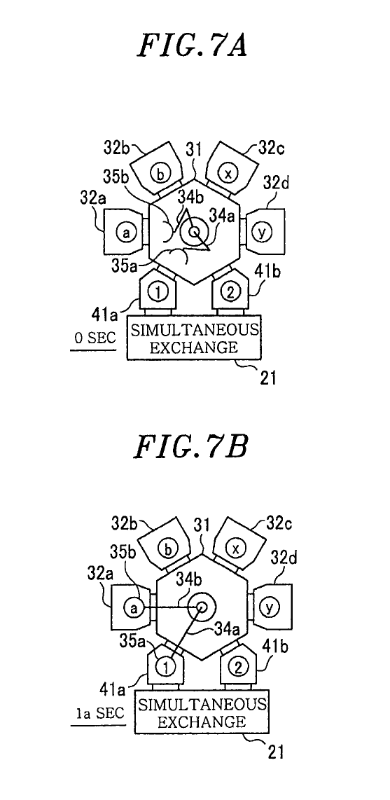

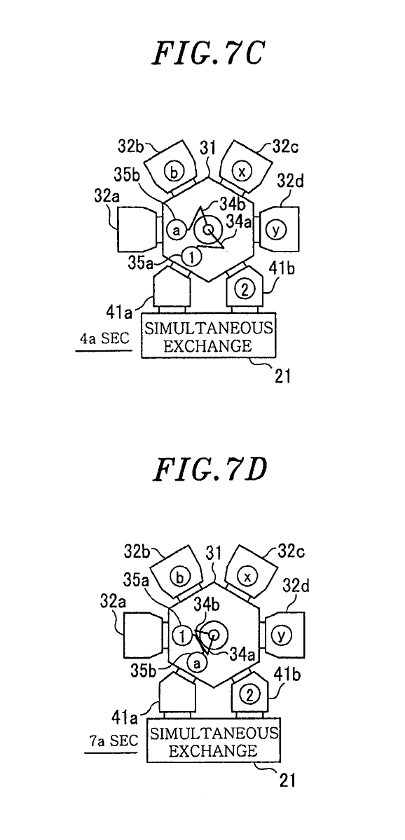

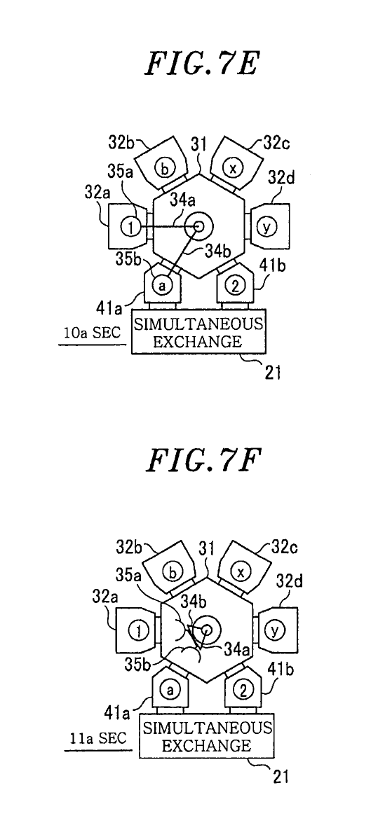

FIGS. 7A to 7F are top views showing transfer sequences of an example of an object transfer method that can be used in the second embodiment of the present invention. FIG. 4C depicts a timing diagram of the object transfer method. Further, in FIGS. 7A to 7F, the illustration of the loading ports 22a to 22c and the orienter 23 is omitted.

First, as shown in FIGS. 7A and 4C, the transfer arms 34a and 34b are rotated to move the pick 35a holding no wafer to the front of the load-lock chamber 41a and to move the pick 35b holding no wafer to the wafer transfer position in front of the processing chamber 32a among the four processing chambers 32a to 32d.

In this state, a simultaneous exchange operation of simultaneously exchanging the processed wafer “a” and the unprocessed wafer “1” is initiated.

At an initial sequence of the exchange operation, the transfer arm 34a is extended into the load-lock chamber 41a, and the unprocessed wafer “1” accommodated in the load-lock chamber 41a is picked up by the pick 35a. At the same time, the transfer arm 34b is extended into the processing chamber 32a, and the processed wafer “a” accommodated in the processing chamber 32a is picked up by the pick 35b.

In this sequence, as shown in FIGS. 7B and 4C, the transfer arms 34a and 34b are extended to move the pick 35a from the transfer chamber 31 to the load-lock chamber 41a and to move the pick 35b from the transfer chamber 31 to the processing chamber 32a. The time required to reach this state is about 1a seconds. Next, as shown in FIGS. 7C and 4C, the unprocessed wafer “1” in the load-lock chamber 41a is picked up by the pick 35a, and the processed wafer “a” in the processing chamber 32a is picked up by the pick 35b. Thereafter, the transfer arms 34a and 34b are retracted to unload the unprocessed wafer “1” and the processed wafer “a” into the transfer chamber 31. The time required to reach this state is about 4a seconds.

Then, there will be carried out a sequence in which the transfer arms 34a and 34b are rotated to move the pick 35a holding the unprocessed wafer “1” to the wafer transfer position in front of the processing chamber 32a, and to move the pick 35b holding the processed wafer “a” to the wafer transfer position in front of the load-lock chamber 41a.

In this sequence, as shown in FIGS. 7D and 4C, the transfer arms 34a and 34b are rotated in the counterclockwise direction by using the θ1 axis to move the pick 35a to the wafer transfer position in front of the processing chamber 32a. The transfer arm 34b is rotated in the counterclockwise direction by using the θ2 axis to move the pick 35b to the wafer transfer position in front of the load-lock chamber 41a. The time required to reach this stage is about 7a seconds.

Next, there will be carried out a sequence in which the transfer arm 34a is extended into the processing chamber 32a to accommodate the unprocessed wafer “1” held by the pick 35a in the processing chamber 32a and at the same time, the transfer arm 34b is extended into the load-lock chamber 41a to accommodate the processed wafer “a” held by the pick 35b in the load-lock chamber 41a.

In this sequence, as shown in FIGS. 7E and 4C, the transfer arms 34a and 34b are extended to move the pick 35a from the transfer chamber 31 to the processing chamber 32a and to move the pick 35b from the transfer chamber 31 to the load-lock chamber 41a. Next, the unprocessed wafer “1” is transferred from the pick 35a to the mounting table (not shown) in the processing chamber 32a, and the processed wafer “a” is transferred from the pick 35b to the mounting table (not shown) in the load-lock chamber 41a. The time required to reach this state is about 10a seconds. Then, as shown in FIGS. 7F and 4C, the transfer arms 34a and 34b are retracted to return the pick 35a from the processing chamber 32a to the transfer chamber 31 and to return the pick 35b from the load-lock chamber 41a to the transfer chamber 31. The time required to reach this state is about 11a seconds.

In this manner, the simultaneous exchange operation of the processed wafer “a” and the unprocessed wafer “1” is completed.

Thereafter, a next simultaneous exchange operation for simultaneously exchanging, e.g., a processed wafer “b” and an unprocessed wafer “2”, is carried out. At this time, the pick 35a is moved to the wafer transfer position in front of the load-lock chamber 41b, and the pick 35b is moved to the wafer transfer position in front of the processing chamber 32b. In this simultaneous exchange operation, the picks 35a and 35b are not holding wafers and thus can be more quickly rotated by using the θ1 axis and the θ2 axis, compared to when they are holding wafers. The pick 35b may be slowly rotated by using the θ2 axis, compared to the pick 35a. The time needed to move the pick 35a to the front of the load-lock chamber 41b and the pick 35b to the front of the processing chamber 32b is about 2a seconds, as shown in FIG. 4C.

However, in the simultaneous exchange operation, the time available for opening and closing the gate valves G1 to G6 disposed between the processing chambers 32a to 32d and the transfer chamber 31 and between the load-lock chambers 41a and 41b and the transfer chamber 31 is reduced, and a new system rate limiting may occur in addition to the transfer rate limiting and the process rate limiting. For example, when the transfer arms are rotated at a high speed and the parameter “a” depending on the type of the transfer arm is a considerably short time, the throughput of the transfer mechanism 33 easily causes the system rate limiting due to the operations of the processing chambers 32a to 32d, the load-lock chambers 41a and 41b, and the transfer chamber 31, and the gate valves G1 to G6.

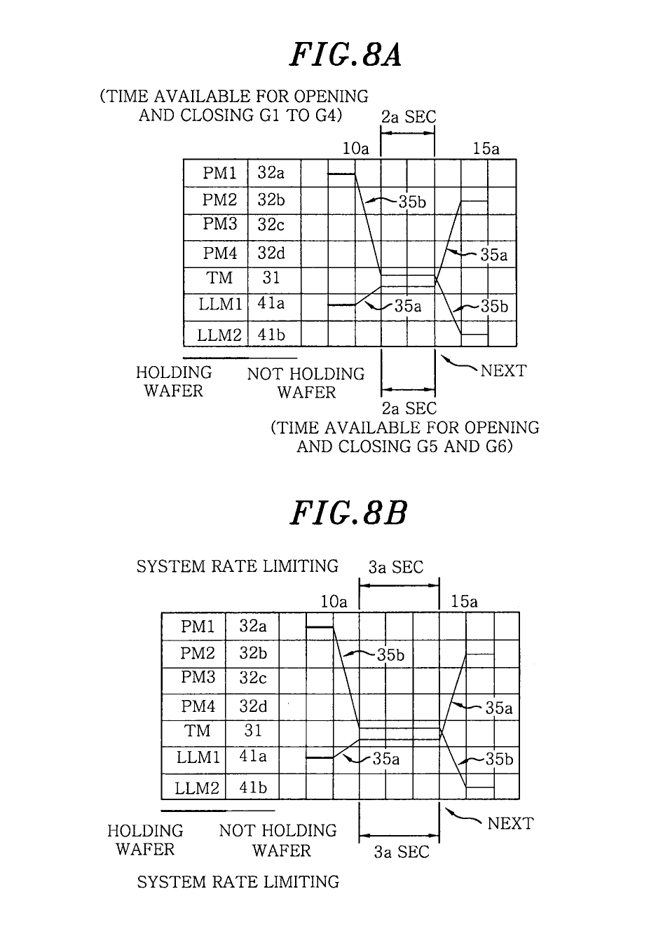

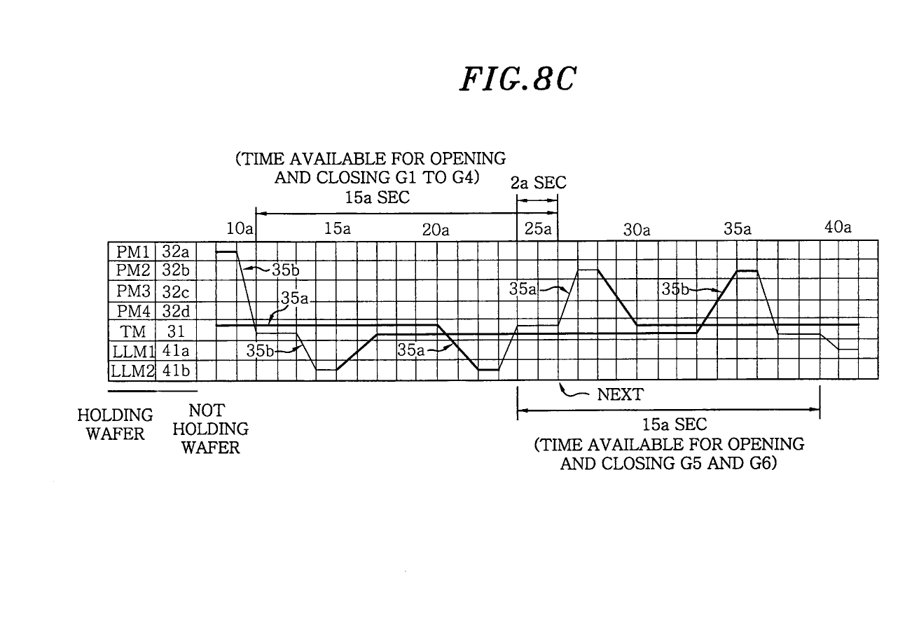

FIG. 8A is a timing diagram showing a period of time available for opening and closing the gate valves G1 to G6 in the simultaneous exchange operation.

As shown in FIG. 8A, in the simultaneous exchange operation, the gate valves G1 to G4 can be opened and closed for, e.g., about 2a seconds, which is a period of time between the state in which the pick 35b is returned from the processing chamber 32a to the transfer chamber 31 and the state in which the pick 35a is moved from the transfer chamber 31 to the processing chamber 32b.

In the same manner, the gate valves G5 and G6 can be opened and closed for, e.g., about 2a seconds, which is a period of time between the state in which the pick 35a is returned from the load-lock chamber 41a to the transfer chamber 31 and the state in which the pick 35b is moved from the transfer chamber 31 to the load-lock chamber 41b.

If the opening and closing of the gate valves G1 to G6 is not completed for about 2a seconds, the system rate limiting occurs. When the system rate limiting occurs, as can be seen from a timing diagram of FIG. 8B, even though the transfer mechanism 33 itself can rotate the transfer arms 34a and 34b for about 2a seconds and start the next simultaneous exchange operation after about 2a seconds, a period of time longer than 2a seconds, e.g., about 3a seconds, is actually required to start the next simultaneous exchange operation.

On the contrary to the simultaneous exchange operation, in the first embodiment, the opening/closing timing of the gate valves G1 to G4 does not coincide with the opening/closing timing of the gate valves G5 and G6. That is, the opening/closing thereof does not simultaneously occur.

Hence, as can be seen from a timing diagram of FIG. 8C, the gate valves G1 to G4 can be opened and closed for, e.g., about 15a seconds, which is a period of time between the state where the pick 35b is returned from the processing chamber 32a to the transfer chamber 31 and the state where the pick 35a is moved from the transfer chamber 31 to the processing chamber 32b.

In the same manner, the gate valves G5 and G6 can be opened and closed for, e.g., about 15a seconds, which is a period of time between the state where the pick 35a is returned from the load-lock chamber 41b to the transfer chamber 31 and the state where the pick 35b is moved from the transfer chamber 31 to the load-lock chamber 41a.

Accordingly, in accordance with the first embodiment, the system rate limiting hardly occurs, compared to the transfer method for performing the simultaneous exchange operation.

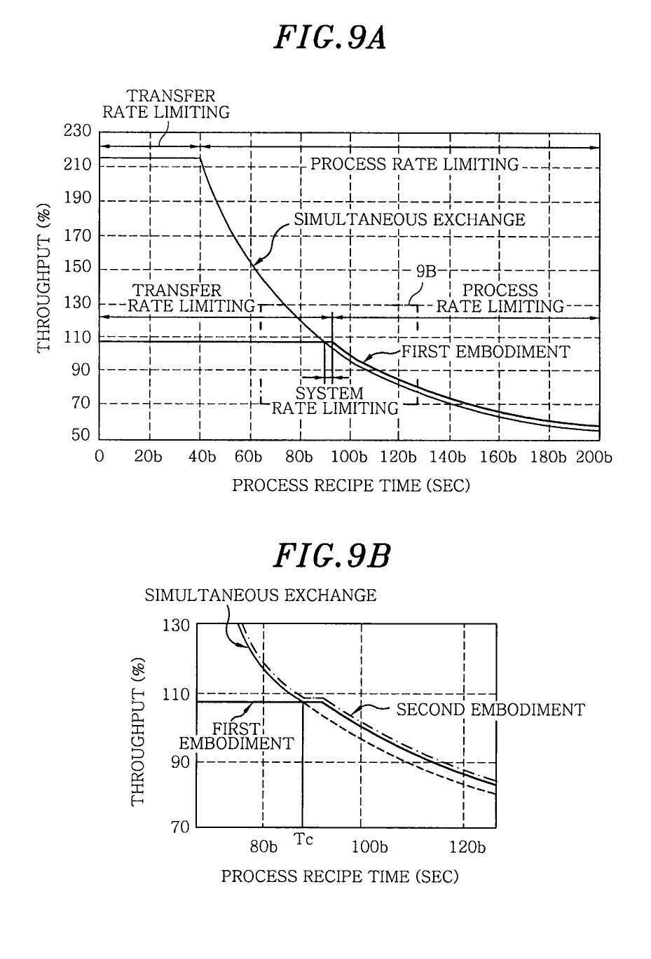

FIG. 9A shows the relationship between a throughput and a process recipe time of the transfer method of the first embodiment and the transfer method for performing the simultaneous exchange operation.

As shown in FIG. 9A, when the process recipe time is short, the transfer method for performing the simultaneous exchange operation provides a better throughput. However, when the transfer method for performing the simultaneous exchange operation causes the system rate limiting, a throughput of the first embodiment becomes higher at a certain process recipe time.

This is because the time required to complete the wafer exchange operation and rotate the transfer arms 34a and 34b for the next exchange operation is about 2a seconds in the first embodiment in which the system rate limiting does not occur. On the contrary, in the simultaneous exchange operation in which the system rate limiting occurs, the time required from when the wafer exchange operation is completed to when the next exchange operation starts is, e.g., about 3a seconds, due to the constraint of the system, e.g., the constraint of the opening/closing operation of the gate valves G1 to G6.

FIG. 9B is an enlarged view of a frame 9B shown in FIG. 9A.

Therefore, in the second embodiment, as indicated by a dot-dash line in FIG. 9B, when the process recipe time is short, the transfer method for performing the simultaneous exchange operation is carried out by using the transfer mechanism 33 having the transfer arms 34a and 34b capable of extending and retracting individually. When the process recipe time is long, the transfer method of the first embodiment is carried out. As can be seen from FIGS. 9A and 9B, the switching between both methods is carried out based on a process recipe time Tc at which a throughput curve in the transfer method for performing the simultaneous exchange operation intersects a throughput curve in the transfer method of the first embodiment and the throughputs are inverted. When the process recipe time is equal to or more than the time Tc, the transfer method of the first embodiment is carried out. When the process recipe time is shorter than the time Tc, the transfer method for performing the simultaneous exchange operation is carried out.

In accordance with the second embodiment, the transfer method for performing the simultaneous exchange operation and the transfer method of the first embodiment are switched depending on the length of the process recipe time. Therefore, compared to the case of using only the transfer method of the first embodiment, the throughput can be further improved even when the process recipe time is short.

Further, the throughput in the long process recipe time can be further improved, compared to the case of using only the transfer method for performing the simultaneous exchange operation.

While the present invention has been described with respect to the above embodiments, the present invention is not limited to the above embodiments and may be variously modified.

In the first embodiment, the transfer mechanism 33 having two transfer arms 34a and 34b and two picks 35a and 35b has been described as an example. However, the number of the transfer arms and the picks is not limited to two, and is preferably two or more. This is because the throughput can be improved by performing the object transfer method of the first embodiment by using two or more transfer arms and picks, e.g., two, four, or six transfer arms and picks.

Although a semiconductor wafer used for manufacturing a semiconductor integrated circuit device has been described as an example of the object to be processed, the object to be processed is not limited to the semiconductor wafer and may also be a glass substrate used for manufacturing a solar cell or a flat panel display.

In addition, the present invention can be variously modified without departing from the scope of the present invention.

In accordance with the present invention, it is possible to provide an object transfer method and an object processing apparatus, capable of solving the problem of limited productivity even if the processing time is shortened.

1. An object transfer method performed by an object processing apparatus which includes: a transfer chamber in which a transfer mechanism for transferring an object is disposed; a plurality of processing chambers, disposed around the transfer chamber, for processing the object; and a plurality of load-lock chambers, disposed around the transfer chamber, for switching an environment around the object to an environment inside the transfer chamber, wherein the transfer mechanism has at least two transfer arms including a first and a second transfer arm that are capable of extending, retracting, and rotating individually, and at least two picks including a first and a second pick attached to the first and the second transfer arm, respectively, for holding the object, the object transfer method comprising:
(0) rotating the first and the second transfer arm to move the first pick holding no object to a first transfer position in front of a first processing chamber of the processing chambers and to move the second pick holding an unprocessed first object to a position adjacent to the first transfer position;
(1) extending the first transfer arm into the first processing chamber, transferring a processed second object accommodated in the first processing chamber to the first pick, and retracting the first transfer arm;
(2) rotating the first and the second transfer arm to move the second pick holding the unprocessed first object to the first transfer position and to move the first pick holding the processed second object to a position adjacent to a second transfer position in front of a first load-lock chamber among the load-lock chambers;
(3) extending the second transfer arm into the first processing chamber, accommodating the unprocessed first object held by the second pick in the first processing chamber, and retracting the second transfer arm;
(4) rotating the second transfer arm to move the second pick holding no object to the second transfer position;
(5) extending the second transfer arm into the first load-lock chamber, transferring an unprocessed third object accommodated in the first load-lock chamber to the second pick, and retracting the second transfer arm;
(6) rotating the first and the second transfer arm to move the first pick holding the processed second object to the second transfer position and to move the second pick holding the unprocessed third object to a position adjacent to the second transfer position; and
(7) extending the first transfer arm into the first load-lock chamber, accommodating the processed second object held by the first pick in the first load-lock chamber, and retracting the first transfer arm.

2. The object transfer method of claim 1, wherein a rotation speed of the second transfer arm in the step (4) is greater than a rotation speed thereof in a case of the second pick holding an object.

3. An object transfer method, wherein a first object transfer method of simultaneously exchanging an unprocessed object and a processed object and a second object transfer method that is the object transfer method described in claim 1 are switched depending on a length of a process recipe time.

4. The object transfer method of claim 3, wherein when the process recipe time is short, the first object transfer method is performed, and when the process recipe time is long, the second object transfer method is performed.

5. The object transfer method of claim 4, wherein in the first object transfer method, an object transfer time becomes a system rate limiting factor and, in the second object transfer method, the object transfer time does not become the system rate limiting factor.

6. The object transfer method of claim 5, wherein the switching of the first and second object transfer methods is performed based on the process recipe time at which a throughput curve in the first object transfer method intersects a throughput curve in the second object transfer method and throughputs are inverted.

7. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 3.

8. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 4.

9. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 5.

10. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 6.

11. An object transfer method, wherein a first object transfer method of simultaneously exchanging an unprocessed object and a processed object and a second object transfer method that is the object transfer method described in claim 2 are switched depending on a length of a process recipe time.

12. The object transfer method of claim 11, wherein when the process recipe time is short, the first object transfer method is performed, and when the process recipe time is long, the second object transfer method is performed.

13. The object transfer method of claim 12, wherein in the first object transfer method, an object transfer time becomes a system rate limiting factor and, in the second object transfer method, the object transfer time does not become the system rate limiting factor.

14. The object transfer method of claim 13, wherein the switching of the first and second object transfer methods is performed based on the process recipe time at which a throughput curve in the first object transfer method intersects a throughput curve in the second object transfer method and throughputs are inverted.

15. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 11.

16. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 12.

17. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 13.

18. An object processing apparatus, comprising:
a transfer chamber in which a transfer mechanism for transferring an object is disposed;
a plurality of processing chambers, disposed around the transfer chamber, for processing the object;
a plurality of load-lock chambers, disposed around the transfer chamber, for switching an environment around the object to an environment inside the transfer chamber; and
a process controller configured to control at least the transfer mechanism,
wherein the transfer mechanism has at least two transfer arms including a first and a second transfer arm that are capable of extending, retracting, and rotating individually and at least two picks including a first and a second pick attached to the first and the second transfer arm, respectively, for holding the object,
wherein the process controller controls the transfer mechanism to perform the object transfer method described in claim 14.
